(19) United States
(12) Patent Application Publication
(10) Pub. No.: US 2025/0309408 A1
(43) Pub. Date: Oct. 2, 2025

(54) SYSTEMS FOR AND METHODS OF COOLING A BATTERY

(71) Applicant: ZeroPointEnergy LLC, Las Vegas, NV (US)

(72) Inventors: Robert C. Lane, Las Vegas, NV (US); Nathan K. Chidiac, Altos Hills, CA (US); Augusto E. Barton, Pinecrest, FL (US)

(21) Appl. No.: 19/089,123

(22) Filed: Mar. 25, 2025

Related U.S. Application Data
(60) Provisional application No. 63/569,905, filed on Mar. 26, 2024.
(60) Provisional application No. 63/634,610, filed on Apr. 16, 2024.

(51) Int. Cl. H01M 10/6568; H01M 10/613; H01M 10/643

(52) U.S. Cl. CPC H01M 10/6568; H01M 10/613; H01M 10/643

(57) ABSTRACT

A battery cooling architecture or assembly includes a cooling volume that surrounds a full perimeter of the battery cell structure, with a uniform flow distribution for all of the cells. This cooling volume can be placed at any position along the cell axial length. The cooling volume can directly cool a selected portion of the cell axial length and, in an alternative embodiment, is able to indirectly cool a larger axial length of the cell with the aid of added sleeves.

### CROSS-REFERENCE TO RELATED APPLICATIONS

This patent application is a non-provisional application of, and claims priority to and the benefit of, both U.S. Provisional Patent Application No. 63/569,905, entitled “SYSTEMS FOR AND METHODS OF COOLING A BATTERY,” filed Mar. 26, 2024, and U.S. Provisional Patent Application No. 63/634,610, entitled “SYSTEMS FOR AND METHODS OF COOLING A BATTERY,” filed Apr. 16, 2024. The entire disclosure of each of the two patent applications identified above is hereby incorporated by reference in its entirety.

### FIELD OF INVENTION

The present invention relates to systems for and methods of cooling a battery, and more particularly, to a battery cooling assembly that includes a cooling volume.

### BACKGROUND

Conventional cooling technologies are often unable to maintain a very uniform cell temperature distribution which causes non-uniform and accelerated cell degradation. Also, in many cases conventional cooling technologies have a very clear challenge in assuring a very uniform battery cell placement. In addition, those technologies require complicated assembly processes with many complex assembly steps that not only require very large capital investments, but also result in high yield loss due to the many complex assembly steps. Many cooling architectures have all those issues.

Conventional cooling architectures are unable to satisfy the safety cell thermal runaway and propagation requirements without the addition of a thermal mitigation agent. The addition of this agent, which in many cases is a variant of a low-density thermal barrier, is one of the more complicated parts of the battery module assembly process, which also adds complexity to the module design as well as cause potential further assembly issues in the assembly line.

In addition, conventional cooling architectures are usually designed to cool the battery cells, but are unable to directly cool the current conducting layers. The current conducting layers normally heat sink to the battery cells, which are then cooled by the cooling element at a different location. This results in the current conducting layer having hot spots, and the cells in a particular area overheating, which further compromises the cell temperature uniformity.

Conventional cooling architectures usually include components which, although they are made from materials that could potentially provide a structural benefit to the battery pack, do not usually do so.

Thus, there is a need for an improved battery cooling system that addresses the drawbacks identified above.

### SUMMARY

A battery cooling architecture or assembly includes a cooling volume that surrounds a full perimeter of the battery cell structure, with a uniform flow distribution for all of the battery cells. The battery cooling architecture can be referred to alternatively as a battery cooling system. This cooling volume can be placed at any position along the cell axial length. The cooling volume can directly cool a selected portion of the cell axial length and, in an alternative embodiment, is able to indirectly cool a larger axial length of the cell with the aid of added sleeves. This cooling volume assembly also enables many different variations of the different elements to be added to the general battery cooling assembly to further enhance its main operating functions. The battery cooling assembly is designed to allow the mass production of a battery cooling assembly that serves not only as a cooling and safety architecture, but also is able to serve as a battery module assembly fixture.

The techniques disclosed herein also relate to a method of manufacturing a battery cooling architecture that includes a cooling volume that surrounds the full perimeter of one or more battery cells, and which provides a uniform flow distribution for all battery cells. The components that are used to form the cooling volume are designed so that the components of the cooling volume architecture can be joined together in one single step or alternatively, can be joined together in sequential steps. The alternative designs disclosed herein for the cooling volume components enable the assembly thereof to be done in one step or in a series of steps.

In one aspect of this disclosure according to the techniques disclosed herein, a battery cooling system for use with one or more battery cells, comprises a cooling volume assembly defining an interior chamber, the cooling volume assembly including an inlet and an outlet, each of the inlet and the outlet being in fluid communication with the interior chamber, and a cooling modular structure spaced apart from the cooling volume assembly, wherein the cooling volume assembly and the cooling modular structure cool the one or more battery cells, and a fluid travels through the inlet, the interior chamber, and the outlet of the cooling volume assembly.

In another aspect, a current conducting layer is connected to the one or more battery cells, and the cooling modular structure is placed in contact with the current conducting layer.

In another aspect, each battery cell of the one or more battery cells includes a first end and a second end opposite to the first end, a current conducting layer is connected to the first end of each battery cell, and the cooling modular structure is placed in contact with the second end of each battery cell.

In another aspect, one or more battery cells defines a perimeter therearound, and the cooling volume assembly extends beyond an entire extent of the perimeter.

In another aspect, each battery cell of the one or more battery cells includes a first end and a second end opposite to the first end, each battery cell including an axial length extending between the first end and the second end.

In another aspect, one of the first end and the second end is a thermal venting side of each battery cell.

In another aspect, the cooling volume assembly is positioned proximate to the second end of each battery cell so that an outer surface of the cooling volume assembly is flush with the second end of each battery cell.

In another aspect, the cooling volume assembly is positioned in an intermediate position along the axial length of each battery cell, and the intermediate position is located between the first end and the second end.

In another aspect, the cooling volume assembly is positioned in an extended position relative to each battery cell, a first part of the cooling volume assembly being adjacent to an outer surface of each battery cell, and a second part of the cooling volume assembly extending beyond the second end of each battery cell.

In another aspect, the cooling volume assembly is positioned in an extended position relative to each battery cell, and the cooling volume assembly extends entirely beyond the second end of each battery cell.

In another aspect, the battery cooling system comprises a cooling sleeve located between the cooling volume assembly and the cooling modular structure, the cooling sleeve defining a passageway therethrough, the passageway receiving one of the one or more battery cells therein.

In another aspect, the battery cooling system comprises a first cooling sleeve located between the cooling volume assembly and the cooling modular structure, the first cooling sleeve defining a first passageway therethrough, the first passageway receiving a first battery cell therein, a second cooling sleeve located between the cooling volume assembly and the cooling modular structure, the second cooling sleeve defining a second passageway therethrough, the second passageway receiving a second battery cell therein, and a heat transfer element coupled to the first cooling sleeve and to the second cooling sleeve.

In another aspect, the battery cooling system comprises a third cooling sleeve located between the cooling volume assembly and the cooling modular structure, the third cooling sleeve defining a third passageway therethrough, the third passageway receiving a third battery cell therein, wherein the first cooling sleeve is spaced apart from the second cooling sleeve by a first distance, the first cooling sleeve is spaced apart from the third cooling sleeve by a second distance, and the second cooling sleeve is spaced apart from the third cooling sleeve by a third distance, the first distance being greater than each of the second distance and the third distance.

In another aspect of this disclosure according to the techniques disclosed herein, a battery cooling system for use with battery cells having a current conducting layer coupled thereto comprises a cooling volume assembly defining an interior chamber, the cooling volume assembly including an inlet and an outlet, each of the inlet and the outlet being in fluid communication with the interior chamber, and a cooling fluid travels through the inlet, the interior chamber, and the outlet of the cooling volume assembly, a cooling modular structure spaced apart from the cooling volume assembly, and a cooling sleeve connected to and located between the cooling volume assembly and the cooling modular structure, the cooling sleeve defining a passageway in which one of the battery cells is located, wherein the cooling volume assembly, the cooling modular structure, and the cooling sleeve cool the battery cells.

In one aspect, each battery cell of the battery cells includes a first end and a second end opposite to the first end, each battery cell including an axial length extending between the first end and the second end.

In another aspect, the cooling volume assembly is positioned proximate to the second end of each battery cell so that an outer surface of the cooling volume assembly is flush with the second end of each battery cell.

In another aspect, the cooling volume assembly is positioned in an intermediate position along the axial length of each battery cell, and the intermediate position is located between the first end and the second end.

In another aspect, the cooling volume assembly is positioned in an extended position relative to each battery cell, a first part of the cooling volume assembly being adjacent to an outer surface of each battery cell, and a second part of the cooling volume assembly extending beyond the second end of each battery cell.

In another aspect of this disclosure according to the techniques disclosed herein, a battery cooling system for use with battery cells in a battery cell grid comprises a cooling volume assembly defining an interior chamber, the cooling volume assembly including an inlet and an outlet, each of the inlet and the outlet being in fluid communication with the interior chamber, a first cooling sleeve engageable with the cooling volume assembly, the first cooling sleeve defining a first passageway in which a first battery cell is located, a second cooling sleeve engageable with the cooling volume assembly, the second cooling sleeve defining a second passageway in which a second battery cell is located, and a heat transfer element coupled to the first cooling sleeve and to the second cooling sleeve, wherein the heat transfer element can transfer heat energy between the first cooling sleeve and the second cooling sleeve.

In one aspect, the battery cooling system comprises a third cooling sleeve engageable with the cooling volume assembly, the third cooling sleeve defining a third passageway in which a third battery cell is located, wherein the first cooling sleeve is spaced apart from the second cooling sleeve by a first distance, the first cooling sleeve is spaced apart from the third cooling sleeve by a second distance, and the second cooling sleeve is spaced apart from the third cooling sleeve by a third distance, the first distance being greater than each of the second distance and the third distance.

### BRIEF DESCRIPTION OF THE DRAWINGS

To complete the description and in order to provide for a better understanding of the present application, a set of drawings is provided. The drawings form an integral part of the description and illustrate embodiments of the present application, which should not be interpreted as restricting the scope of the invention, but just as examples. The drawings comprise the following figures:

FIG. 1 illustrates a schematic drawing of an embodiment of a battery cooling assembly and an exemplary battery according to an aspect of this disclosure.

FIG. 2A illustrates a cross-sectional side view of an embodiment of a battery cooling assembly according to an aspect of this disclosure being used with a battery.

FIG. 2B illustrates a bottom view of the battery cooling assembly and battery illustrated in FIG. 2A.

FIG. 3A illustrates a cross-sectional side view of an alternative embodiment of a battery cooling assembly according to an aspect of this disclosure.

FIG. 3B illustrates a top view of the battery cooling assembly illustrated in FIG. 3A taken along the line “A-A” in FIG. 3A.

FIG. 4A illustrates a cross-sectional side view of another embodiment of a battery cooling assembly according to an aspect of this disclosure being used with a battery.

FIG. 4B illustrates a bottom view of the battery cooling assembly and battery illustrated in FIG. 4A.

FIG. 5A illustrates a cross-sectional side view of an alternative embodiment of a battery cooling assembly according to an aspect of this disclosure.

FIG. 5B illustrates a top view of the battery cooling assembly illustrated in FIG. 5A taken along the line “B-B” in FIG. 5A.

FIG. 6 illustrates a cross-sectional side view of another embodiment of a battery cooling assembly according to an aspect of this disclosure.

FIG. 7 illustrates a bottom view of the battery cooling assembly illustrated in FIG. 6.

FIG. 8 illustrates a cross-sectional side view of another embodiment of a battery cooling assembly according to an aspect of this disclosure being used with a battery.

FIG. 9 illustrates a bottom view of the battery cooling assembly and battery illustrated in FIG. 8.

FIGS. 10-19 illustrate cross-sectional side views of additional embodiments of a battery cooling assembly according to different aspects of this disclosure being used with a battery.

FIG. 20 illustrates a cross-sectional side view of an alternative embodiment of a battery cooling assembly according to an aspect of this disclosure.

FIG. 21 illustrates a top view of the battery cooling assembly illustrated in FIG. 20 taken along the line “C-C” in FIG. 20.

FIG. 22 illustrates a cross-sectional side view of another embodiment of a battery cooling assembly according to an aspect of this disclosure being used with a battery.

FIG. 23 illustrates a cross-sectional top view of the battery cooling assembly and battery illustrated in FIG. 22 taken along the line “D-D” in FIG. 22.

FIG. 24A illustrates a cross-sectional side view of an alternative embodiment of a battery cooling assembly according to an aspect of this disclosure.

FIG. 24B illustrates a top view of the battery cooling assembly illustrated in FIG. 24A taken along the line “E-E” in FIG. 24A.

FIG. 25A illustrates a cross-sectional side view of an alternative embodiment of a battery cooling assembly according to an aspect of this disclosure.

FIG. 25B illustrates a top view of the battery cooling assembly illustrated in FIG. 25A taken along the line “F-F” in FIG. 25A.

FIG. 26A illustrates a cross-sectional side view of an alternative embodiment of a battery cooling assembly according to an aspect of this disclosure.

FIG. 26B illustrates a top view of the battery cooling assembly illustrated in FIG. 26A taken along the line “G-G” in FIG. 26A.

FIG. 27A illustrates a cross-sectional side view of an alternative embodiment of a battery cooling assembly according to an aspect of this disclosure.

FIG. 27B illustrates a top view of the battery cooling assembly illustrated in FIG. 27A taken along the line “H-H” in FIG. 27A.

Like reference numerals have been used to identify like elements throughout this disclosure.

### DETAILED DESCRIPTION

The following description is not to be taken in a limiting sense but is given solely for the purpose of describing the broad principles of the invention. Embodiments of the invention will be described by way of example, with reference to the above-mentioned drawings showing elements and results according to the present invention.

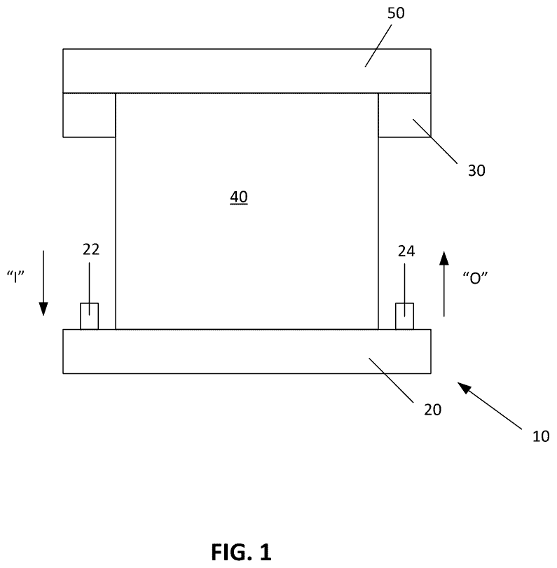

Turning initially to FIG. 1, a schematic drawing of an embodiment of a battery cooling assembly and an exemplary battery according to an aspect of this disclosure is illustrated. As shown, a battery cooling architecture 10 includes a cooling volume assembly 20 that has an inlet 22 and an outlet 24. The cooling volume assembly 20 is a structure that defines an interior region or interior chamber through which a fluid may flow. Each of the inlet and the outlet is in fluid communication with the interior chamber. A fluid, such as a fluid with cooling properties, can flow along the direction of arrow “I” into the chamber via the inlet 22. The fluid can circulate in the chamber of the cooling volume assembly 20, and exit through the outlet 24 along the direction of arrow “O.” The cooling volume assembly 20 is located adjacent to a portion of a battery cell grid 40 which, in different embodiments, can include one or more battery cells. The fluid in the cooling volume assembly 20 absorbs heat from the battery cell grid 40. In one embodiment, a current conducting layer or layers 50 is connected to an end of the battery cell(s) in the battery cell grid 50.

A cooling architecture according to the present disclosure includes a cooling volume that is formed in one embodiment of formed metal and joined metallic parts that assure a hermetically sealed volume. As shown in more detail below, in some implementations, the cooling volume includes circular forms or areas or receptacles that receive battery cells. These circular areas or receptacles accurately determine the battery cell positions of the full module, and also provide the necessary heat transfer area for the thermal control of the battery cells. The circular forms are extruded, which facilitates making shapes that resist buckling and that also create a spring force around a battery cell.

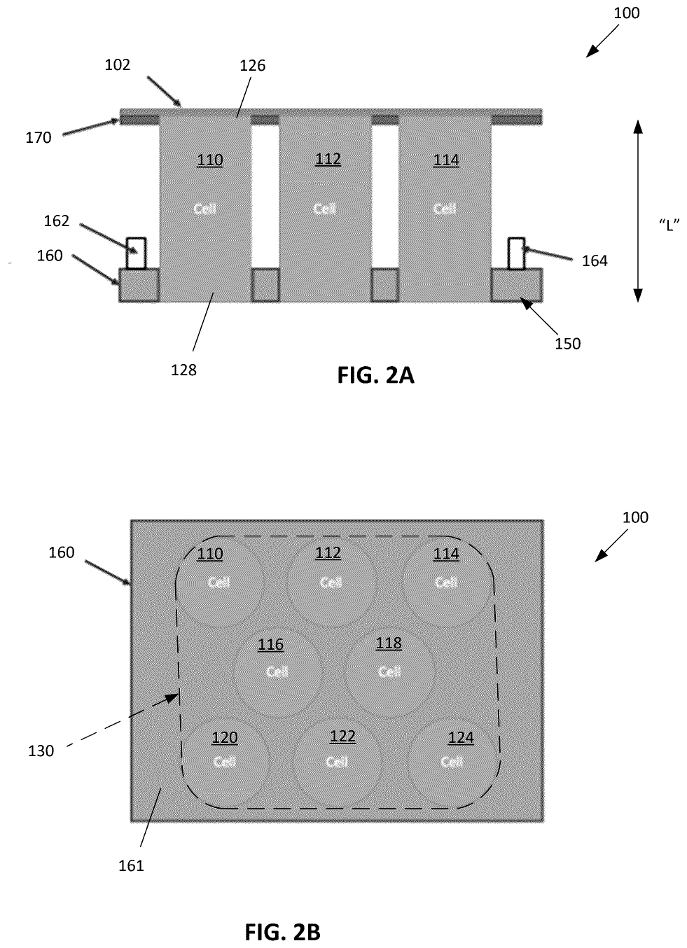

Turning to FIGS. 2A and 2B, a side view and a bottom view, respectively, of an embodiment of a battery cooling assembly according to an aspect of this disclosure being used with a battery are illustrated. In FIGS. 2A and 2B, the battery cooling volume is positioned so that it can cool the battery cells.

In this embodiment, the illustrated battery 100 is exemplary of a battery with which the battery cooling assembly 150 can be used. The battery cooling assembly 150 can be referred to alternatively as a battery cooling architecture. Battery 100 includes several battery cells 110, 112, 114, 116, 118, 120, 122, and 124, which in this embodiment are cylindrical. In different embodiments, the cells of the battery can have cross-sections that are not cylindrical (such as a square cross-section), and the cells of a battery may have varying cross-sectional sizes and/or shapes. Each of the cells has a first end 126 and a second end 128 that is opposite the first end 126. Each cell also includes an axial length “L” that extends from first end 126 to second end 128.

Coupled to the battery cells are current conducting layers 102, which in addition to the cells 110, 112, 114, 116, 118, 120, 122, and 124, also benefits from cooling by the cooling assembly. Referring to FIG. 2B, a perimeter 130 is defined around the battery cells 110, 112, 114, 116, 118, 120, 122, and 124. The perimeter 130 is shown via the dashed line.

Referring back to FIG. 2A, the battery cooling assembly 150 includes a cooling volume assembly 160 that has an interior cavity or receptacle into which a cooling fluid is inserted and can flow. In this embodiment, the cooling volume assembly is located proximate to one end of the battery cells, as described below.

The cooling fluid can enter the assembly 160 through an inlet 162, travel throughout the cavity of the cooling volume assembly 160, which includes traveling around all of the cells as shown in FIG. 2B, and then exit as a warmed fluid through the outlet 164. In this embodiment, both the inlet 162 and the outlet 164 are oriented such that their openings are located inwardly of the cooling assembly, or located along the direction of axial length L toward ends 126. The cooling volume assembly 160 extends around and beyond the entire extent of the perimeter 130 of the battery cells, with portion 161 extending around the perimeter 130. As shown in FIG. 2A, the cooling volume assembly 160 is located proximate to ends 128 of the cells. In this embodiment, the cooling volume assembly 160 is positioned flush with the ends 128 of the cells, and extends toward cell ends 126 along a portion of the axial length L.

The battery cooling assembly according to the present disclosure achieves an improved uniform cell temperature distribution. The cooling volume assembly 160 cools around the full cell perimeter 130, and does so in a well-distributed and uniform manner across all the module battery cells. Referring back to FIG. 2A, the battery cooling assembly 150 includes a cooling modular structure 170, which can be referred to alternatively herein as a modular structural skin, that is located proximate to the current conducting layers 102 in the areas around and between the battery cells.

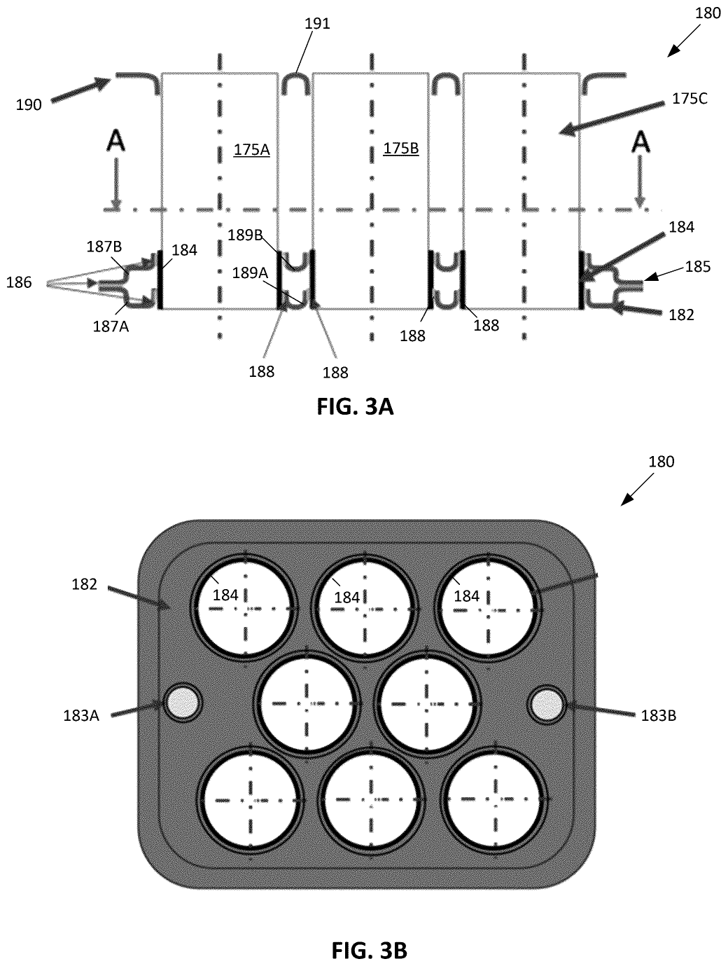

Referring to FIGS. 3A and 3B, an alternative embodiment of a battery cooling assembly according to an aspect of this disclosure is illustrated. In this embodiment, the different components of the cooling volume assembly are configured to allow for the joining thereof during manufacturing of the cooling volume assembly. The battery cooling architecture 180 is used with several battery cells, of which only battery cells 175A, 175B, and 175C are illustrated in FIG. 3A.

The battery cooling architecture 180 includes a cooling volume assembly 182 that has an inlet 183A and an outlet 183B, and a modular structural skin 190. The modular structural skin 190 has a swage for every matching metal sleeve. Swage 191 is identified in FIG. 3A as an example. Swage 191 is located between adjacent sleeves.

In this embodiment, cooling volume assembly 182 and structural skin 190 are not joined to each other. Instead, each of the cooling volume assembly 182 and structural skin 190 is jointed directly to the battery cell casing, as shown in FIGS. 3A and 3B. In particular, cooling volume assembly 182 is coupled to sleeves 184, which in this embodiment, do not extend along the full length of battery cells. The locations at which the cooling volume assembly 182 and sleeves 184 are coupled or joined are joint areas 186 and 188. As shown in FIG. 3A, the cooling volume assembly 182 has a bottom tray 185 that includes a bottom portion 187A and an upper portion 187B that are coupled together at joint area 186. In this embodiment, the inner ends of bottom portion 187A and upper portion 187B are oriented upwardly along sleeve 184. The bottom tray 185 includes swage portions 189A and 189B between adjacent sleeves. In this implementation, the swage portions 189A and 189B are positioned so that their bonds ends are oriented upwardly as shown.

The metal cooling volume assembly components can be joined or coupled by one of several different methods, one which being brazing. Alternative coupling methods include fasteners with or without a sealant, welding, adhesive bonding, soldering, friction stir welding, or other methods.

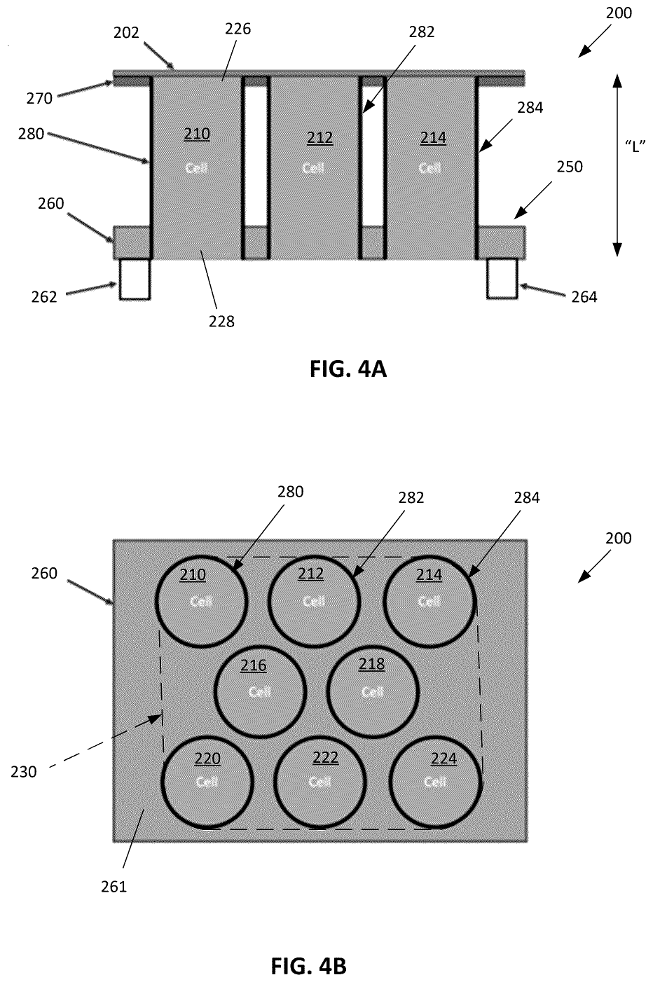

Turning to FIGS. 4A and 4B, a side view and a bottom view, respectively, of another embodiment of a battery cooling assembly according to an aspect of this disclosure being used with a battery are illustrated.

In this embodiment, the battery 200 includes several battery cells 210, 212, 214, 216, 218, 220, 222, and 224, which in this embodiment are cylindrical. Each of the cells has a first end 226 and a second end 228 that is opposite the first end 226. Each cell also includes an axial length “L” that extends from first end 226 to second end 228. Similar to battery 100, coupled to the battery cells 210, 212, 214, 216, 218, 220, 222, and 224 are current conducting layers 202. Referring to FIG. 4B, a perimeter 230 is defined around the battery cells 210, 212, 214, 216, 218, 220, 222, and 224, which is shown via the dashed line.

Battery cooling assembly 250 includes a cooling volume assembly 260 that has an interior cavity or receptacle into which a cooling fluid is inserted and can flow. In this embodiment, the cooling volume assembly 260 is located proximate to ends 228 of the battery cells (see FIG. 4A).

The cooling fluid can enter the assembly 260 through an inlet 262, travel throughout the cavity of the assembly 260 around all of the cells, and then exit as a warmed fluid through the outlet 264. In this embodiment, both the inlet 262 and the outlet 264 are oriented such that their openings are located outwardly of the cooling assembly, or located along the direction of axial length L away from ends 228. The cooling volume assembly 260, including portion 261, extends around the perimeter 230 of the battery cells. In this embodiment, the cooling volume assembly 260 is positioned flush with the ends 228 of the cells.

Referring to FIG. 4A, the battery cooling assembly 250 includes a modular structural skin 270 that is located proximate to the current conducting layers 202 in the areas around and between the battery cells.

In this embodiment, the battery cooling assembly 250 includes several cooling sleeves, each of which surrounds one of the battery cells. As shown in FIG. 4A, each of the cooling sleeves extends around each cell from first end 126 to second end 128. In this embodiment, cooling sleeve 280 surrounds cell 210, cooling sleeve 282 surrounds cell 212, and cooling sleeve 284 surrounds cell 214. In addition, as shown in FIG. 4B, additional cooling sleeves are located around cells 216, 218, 220, 222, and 224.

The sleeves further improve the ability of the cooling volume assembly 250 to transfer heat to or from the cells and improve its thermal uniformity depending on the material, the axial length of the cells, and the thicknesses of the sleeves. The cell-to-cell and the cell-to-cooling fluid electrical isolation can be achieved with several different methods. The methods include dielectric coatings, dielectric sleeves between the cells and the cooling volume, or others for which different type of materials can be used.

When adding the cooling sleeves, the amount of the thermal transfer area to the whole cell cylindrical surface is increased by the presence of the cooling sleeves. This increased thermal transfer area results in an improved cell temperature uniformity compared to conventional cooling technologies. Due to the increased thermal transfer area and a more open flow area, the resulting pressure drop of the cooling fluid is lower than conventional cooling technologies, even for a same cooling fluid temperature rise for a same total cell heat load.

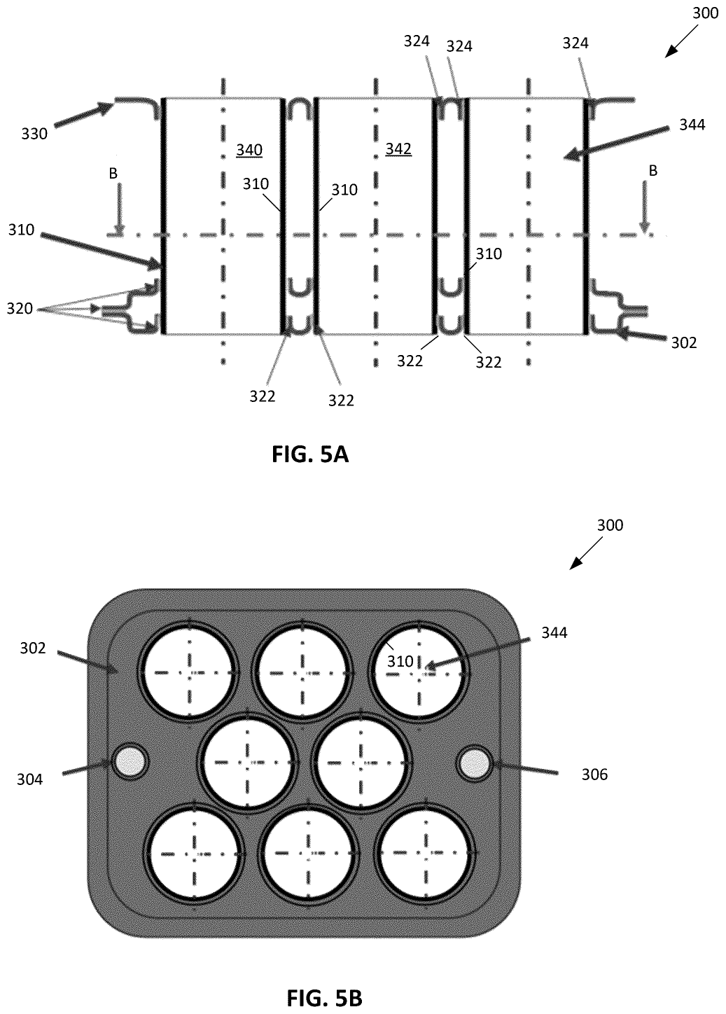

Referring to FIGS. 5A and 5B, another embodiment of a battery cooling assembly according to an aspect of this disclosure is illustrated. In this embodiment, the different components of the cooling volume assembly are configured to allow for the joining thereof during manufacturing of the cooling volume assembly. The battery cooling architecture 300 is used with several battery cells, of which only battery cells 340, 342, and 344 are illustrated in FIG. 5A.

The battery cooling architecture 300 includes a cooling volume assembly 302 that has an inlet 304 and an outlet 306, and a modular structural skin 330. In this embodiment, cooling volume assembly 302 and structural skin 330 are joined to each other via metal sleeves 310, as shown. In this embodiment, the metal sleeves 310 extend along the full length of battery cells. Cooling volume assembly 302 and structural skin 330 are coupled to sleeves 310 via various joint areas 320, 322, and 324.

The metal cooling volume assembly components, including the sleeves and the structural skin, can be joined or coupled by several different methods, one which being brazing. Alternative coupling methods include fasteners with or without a sealant, welding, adhesive bonding, soldering, friction stir welding, or other methods.

For the method of brazing, there are several material choices. One possible combination of materials—aluminum for the sleeves, single-sided clad aluminum for the top tray of the cooling volume, double-sided clad aluminum for the bottom tray of the cooling volume, single-sided clad aluminum for the module structural skin, and single-sided clad aluminum for the inlet and outlet fittings. The design is tolerant of a wide range of material thicknesses. In different embodiments, the choice of thickness for the materials depends on the thermal, structural, and other performance and manufacturability requirements. The assembly fixture required to braze the full cooling volume assembly in a single step may be a base, side panels, a top panel, and a few locking features, as needed. The base provides proper bottom support structure. The side panels control the position of the bottom tray of the cooling volume, top tray of the cooling volume, and the structural skin. The top panel provides proper top support structure. The design of the brazing fixture also takes into consideration limiting how much heat is extracted from the brazing fixture. These are common but worth mentioning practices.

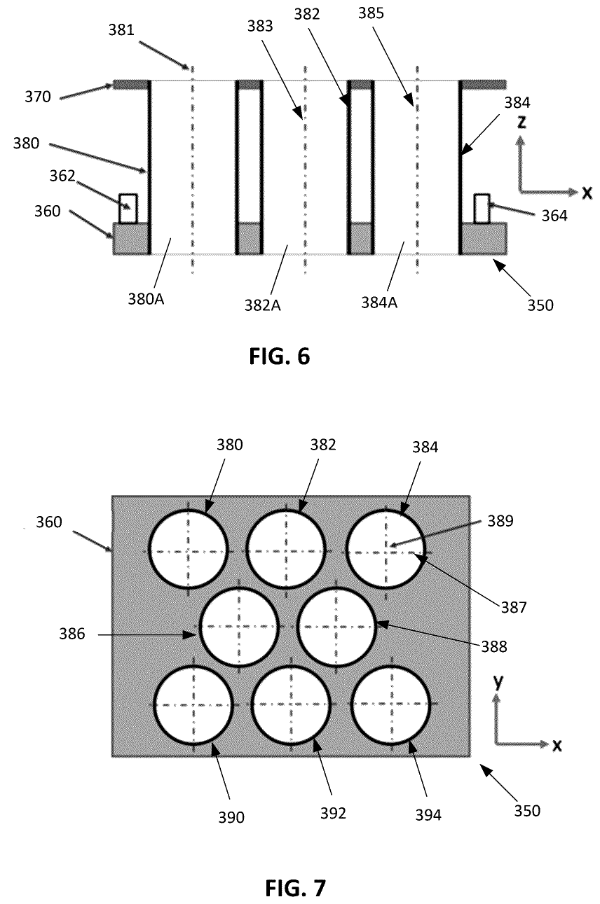

Referring to FIGS. 6 and 7, a side view and a bottom view, respectively, of another embodiment of a battery cooling assembly according to an aspect of this disclosure are illustrated. In this embodiment, the cooling volume architecture can control the positions of all of the battery cells in the module by controlling the radial spacing as well as keeping them at their controlled axial orientation with minimum angular deviation. Accordingly, unlike conventional cooling architectures that require assembly fixtures to control battery cell positions, the cooling volume architecture disclosed herein does not require any additional assembly fixture to maintain the positions and stability of the battery cells.

Battery cooling assembly or architecture 350 includes a cooling volume assembly 360 with an inlet 362 and an outlet 364 for fluid to enter into the cooling volume assembly 360 and exit therefrom, respectively. The inlet 362 and the outlet 364 are oriented toward the module structural skin 370 of the cooling volume assembly 360. The modular structural skin 370 has cooling properties.

In FIG. 6, the battery cells are not shown for simplicity of the description. Sleeves 380, 382, and 384 extend between the cooling volume assembly 360 and the module structural skin 370. Sleeves 380, 382, and 384 define passageways 380A, 382A, and 384A therethrough, and each of the passageways 380A, 382A, and 384A receives and surrounds the inserted battery cell. The cooling effect of the cooling fluid circulating within and passing through cooling volume assembly 360 assists and improves the net cooling effect of the cooling sleeves 380, 382, and 384, which are in contact with module structural skin 370 as well, and can be referred to as openings in the cooling volume assembly 360.

The sleeves 380, 382, and 384 provide a cell axial (Z-axis) tilt control support, or longitudinal alignment support, for the battery cells. Sleeves 380, 382, and 384 have longitudinal axes 381, 383, and 385, respectively. The sleeves 380, 382, and 384 are oriented so that they hold their respective battery cells aligned with longitudinal axes 381, 383, and 385.

In addition, the sleeves of battery cooling assembly or architecture 350 provide lateral alignment support for the battery cells as well. Referring to FIG. 7, the battery cooling architecture 350 includes sleeves 380, 382, 384, 386, 388, 390, 392, and 394 that extend upwardly from the cooling volume assembly 360. Each of the sleeves provides cell radial position support, or lateral alignment support, relative to the X-axis and Y-axis, which for sleeve 384 are labeled as horizontal or lateral axis 387 and as horizontal or lateral axis 389, respectively. In FIG. 7, each of the axes 387 and 389 are illustrated for each sleeve of cooling volume assembly 360.

As set forth below in greater detail, in general, the battery cooling architectures disclosed herein have several advantages. One advantage is improved cell temperature uniformity and lower cooling fluid pressure drop compared to conventional cooling technologies even at the same cooling fluid temperature rise for the same total cell heat load. Another advantage is that conventional cooling architectures rely on assembly fixtures to control the cell position during the assembly process, while the architectures disclosed herein control the cell position without the aid of an assembly fixture. An additional advantage is that the disclosed architectures can improve thermal safety and do not require the addition of thermal mitigation agents, such as foam, used by conventional systems. The disclosed architectures separate the vent volume and the battery cell grid from each other, and this is done using metal, instead of a thermal mitigation material, such as foam, as used by the conventional systems. Those thermal mitigation agents usually do not contribute a major structural benefit and make the assembly of the module more complex. A yet another advantage is that the current conducting layer, referred to alternatively as a current collector, would be cooled more directly and be able to operate at a lower temperature, which would have a positive impact on its operating lifetime and would also allow the current collector design to be of thinner metal resulting in mass and cost savings. Additionally, the architectures disclosed herein would be able operate at higher peak currents than conventional systems. Another advantage is that the cooling volume assembly has a honeycomb-like structure, which in combination with the battery cells inside the sleeves that make them practically a solid structural element, results in a generally solid structural module assembly. A yet another advantage is that the battery cooling architecture design also has the flexibility to easily adjust its dimensions to any desired uniform or non-uniform cell-to-cell spacing.

The present invention allows the joining of the full assembly of the cooling volume parts in a single step. This ability is significant because the single step process results in the easy assembly of the system to achieve the advantages disclosed herein. In addition, the manufacturing methods disclosed herein have the advantage of significantly reducing the complexity of the module assembly process because they does not require the use of an assembly fixture to locate the battery cells. In addition, the design of the battery cooling architecture enables good position control of the battery cells. This results in reducing the overall manufacturing costs of module assembly lines and the operational expenses in running the production lines.

The battery cooling architecture according to the aspects of this disclosure improves thermal safety because it does not require the addition of thermal mitigation agents, which are used in conventional systems. Those thermal mitigation agents usually do not contribute a major structural benefit, and also make the assembly of the module more complex. First, the battery cooling architectures disclosed herein do not require such agents because the architectures prevent hot thermal runaway gases from entering the battery cell matrix compared to conventional systems which utilize thermal mitigation agents to prevent the hot thermal gases entering the cell grid. Second, the battery cooling architectures disclosed herein have the ability to better thermally soak the heat from the runaway cell with a larger portion of the battery module thermal mass. In one aspect, that is due to the cooling volume having a full area coverage of the cell grid. In another aspect, that is also due to the cooling volume having a high thermally conductive metal that extends across all the battery cells which are coupled by the cooling volume having a thermal contact around the cylindrical area for all battery cells in the cell grid. Additionally, any battery cells that go into thermal runaway remain well thermally coupled even at high temperatures where thermal interface materials could start losing their thermal conductivity properties. This is due to the cooling volume metal being able to maintain a tight gap with the thermal runaway cells. In comparison, conventional systems are unable to keep the thermal runaway cells well thermally coupled to their cooling devices because at high temperatures their thermal interface materials lose their capacity to effectively transfer heat. Also the thermal runaway cells are unable to keep a tight gap with their cooling devices and accordingly lose their ability to heat sink and distribute heat to the rest of the cell grid thermal mass with their aid.

Another aspect of the battery cooling architectures disclosed herein is the cooling of the current conducting layer or layers. In this aspect, the current conducting layer or layers have a thermal connection directly coupled to the cooling volume assembly. This thermal connection has a significant effect improving the current conducting layer temperature uniformity and maintaining it operating at a lower temperature. This prevents the current conducting layer from sinking its heat mainly through the electrical connections to the battery cells, which also prevents the battery cells from having hot spots near those connections to the current conducting layer. The current conducting layer can operate at a lower temperature which improves its operating lifetime, and allows the current conducting layer to be thinner, thereby resulting in reduced mass and improved cost savings. Additionally, the current conducting layer is able operate at higher peak currents relative to conventional systems due to their low thermal mass of the current conducting layer and its ineffective cooling.

A yet another aspect of the battery cooling architectures disclosed herein is structural aspects and support. The cooling volume assembly is designed in a honeycomb-like structure. This structure is formed by cylindrical sleeves on every battery cell that are joined on one axial end to two joined metal layers of the cooling volume assembly, and on the opposing axial end to another metal layer skin. Additionally, the battery cells inside the sleeves provide further structural stiffness to the cylindrical sleeves, which results in the sleeve-cell assembly practically being a solid structural element. The only relative movement left in the cooling volume assembly with the battery cells is due to the deformation of the skins near the axial ends of the sleeves. Since the skins are separated by a large gap approximately equal to the cell axial length the module structural assembly stiffness is rather large due to its large moment of inertia provided by the skins and the sleeves that connect them. Thus, the resulting battery cooling architecture along with the battery cells provides a solid structural module assembly. This module assembly design can be used to enable a structural battery pack which can increase the vehicle frame structural integrity.

The battery cooling architectures disclosed herein allow for the addition of metal pieces that strategically connect the cooling volume cell sleeves so they can more effectively transfer heat from a hot thermal runaway battery cell to other battery cells that are not immediately near to a hot thermal runaway battery cell. With the proper sizing of those elements, the thermal soaking of the thermal runaway battery cell to the rest of the battery module thermal mass can be improved.

It is to be understood that the foregoing advantages, benefits, and features of the described battery cooling architectures can be achieved in different variants of the battery cooling architectures. The following architecture variants result in similar solutions, with each of the variants having their own advantages. The variants contemplated according to the aspects of this disclosure include the following embodiments and the combination of features from the different embodiments.

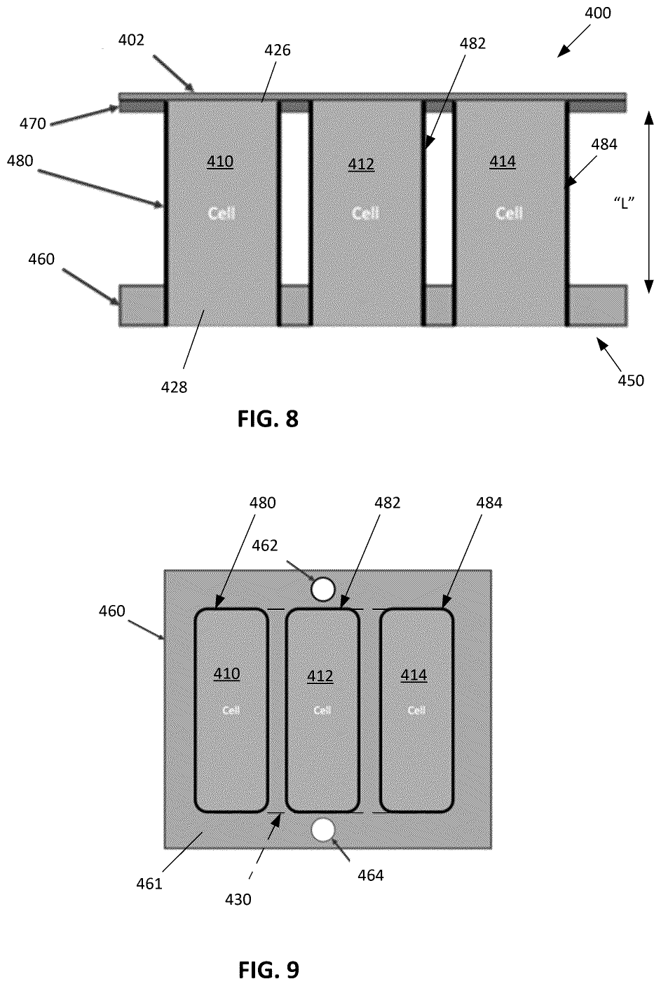

Turning to FIGS. 8 and 9, a side view and a bottom view of another embodiment of a battery cooling assembly according to an aspect of this disclosure being used with a battery are illustrated. In different embodiments, the size and the shape or configuration of the battery cells may vary relative to the previously described embodiments. For example, the battery cells, and any corresponding sleeves for the battery cells, may have shapes or configurations that are different from a cylindrical shape or configuration, such as prismatic configurations or pouch-shaped cells. In this embodiment, the battery 400 has battery cells 410, 412, and 414 with first ends 426 connected to a current conducting layer 402 and opposite second ends 428 that are spaced apart from the first ends 426 along an axial length “L”.

In this embodiment, the battery cooling architecture 450 includes a cooling volume assembly 460 with a receptacle for a cooling fluid, and an inlet 462 and an outlet 464 for the cooling fluid to flow therethrough. As shown, there are three sleeves 480, 482, and 484 located between the cooling volume assembly 460 and a module structure skin 470, which is adjacent to and in contact with current conducting layer 402. The pouch-shape of the cells 410, 412, and 414 and their corresponding sleeves 480, 482, and 484 are illustrated in FIG. 9. The cells 410, 412, and 414 collectively have a perimeter 430 about which a portion 461 of the cooling volume assembly 460 is located.

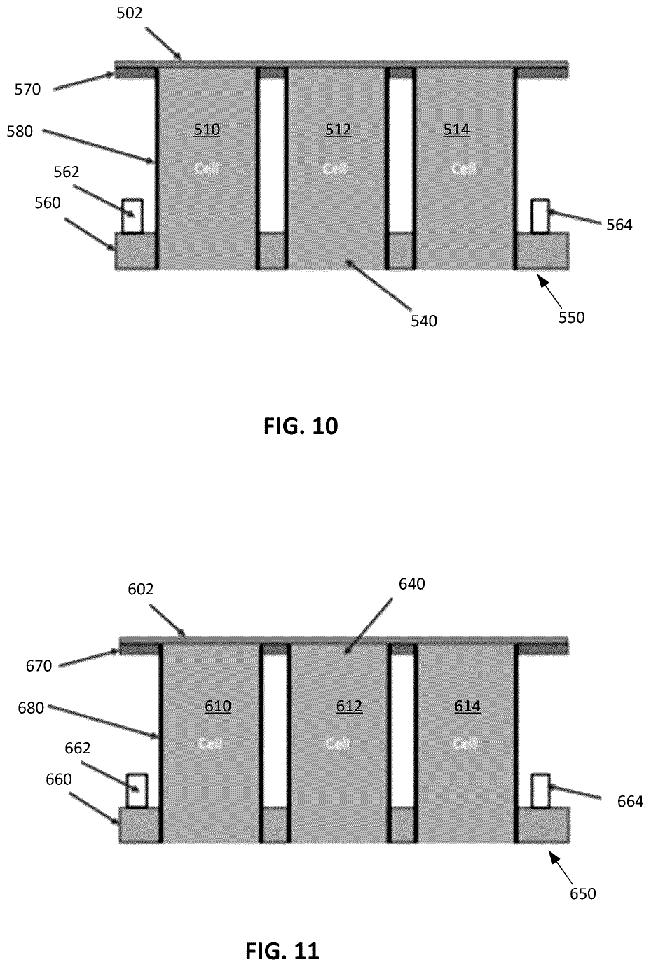

Another set of alternative embodiments relate to the location of the battery cell thermal event vent. In different embodiments, the battery cell vent location can vary, as shown in FIGS. 10-13.

In one implementation, see FIG. 10, the thermal venting side of the battery cells is located on the same end of the battery cells as the cooling volume assembly. As shown, this end of the battery cells is opposite the positive terminals of the battery cells and the current conducting layers. In particular, battery cells 510, 512, and 514 are connected to current conducting layer 502 at one end, and their opposite ends are the thermal venting side of the cells 510, 512, and 514. The battery cooling architecture 550 includes a cooling volume assembly 560 having an inlet 562 and an outlet 564. The cooling volume assembly 560 is located at the opposite end of the sleeves (only sleeve 580 is labeled for simplicity) and cells 510, 512, and 514 from module structural skin 570, which is adjacent to current conducting layer 502.

In another implementation, see FIG. 11, the thermal venting side of the battery cells is located on the same end of the battery cells as the cell positive terminal and current conducting layers, which is the end opposite to where the cooling volume assembly is located. In particular, the positive terminal ends of the battery cells 610, 612, and 614 are connected to current conducting layer 602. Those ends of the battery cells are the thermal venting side 640 of the cells 610, 612, and 614 in this embodiment. The battery cooling architecture 650 includes a cooling volume assembly 660 having an inlet 662 and an outlet 664. The cooling volume assembly 660 is located at the opposite end of the sleeves 680 and cells 610, 612, and 614 from module structural skin 670, which is adjacent to current conducting layer 602.

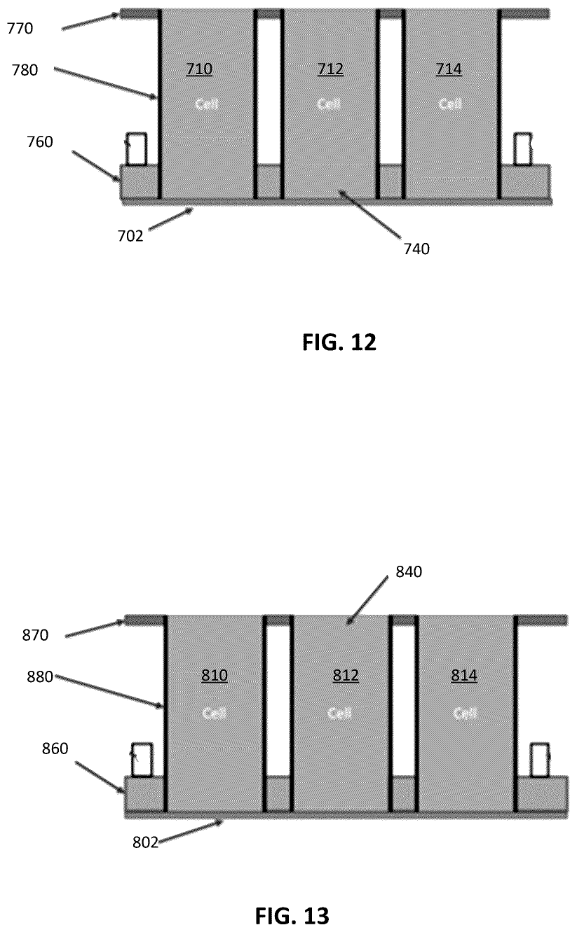

In another implementation, see FIG. 12, the cell vent location 740 is on the same end of the battery cells 710, 712, and 714 as the cooling volume assembly 760, the cell positive terminal, and the current conducting layers 702. The module structural skin 770 is located at the opposite end of the battery cells 710, 712, and 714 and sleeves 780.

In yet another implementation, see FIG. 13, the cell vent location 840 is on the opposite side of the cell positive terminals of the battery cells 810, 812, and 814, the cooling volume assembly 860, and the current conducting layers 802. The module structural skin 870 is located at the same end of the battery cells 810, 812, and 814 and sleeves 880 as the cell vent location 840.

Another variation of the battery cooling architecture embodiments disclosed herein relates to the particular orientation of the battery cells. In some embodiments, the battery cells are orientated vertically, and have the thermal event vent facing down. In such an arrangement, that orientation for an electric vehicle directs the venting away from the cabin. However, alternative architecture designs may include vertical battery cells venting upwards or even horizontal battery cells venting to either side, which may be necessary for battery module packaging reasons within a battery pack.

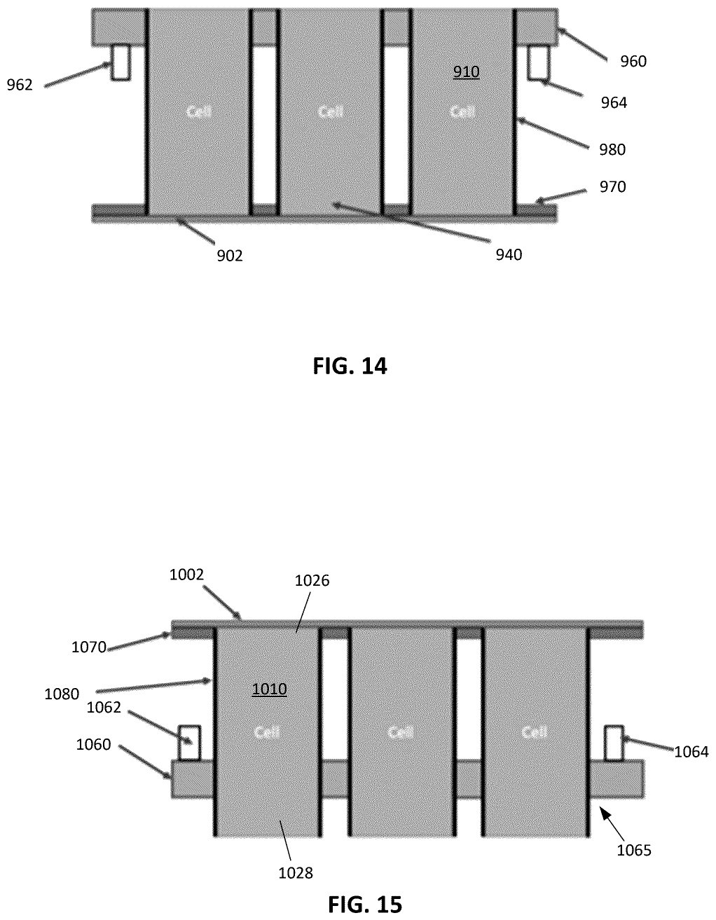

A yet another variation of the battery cooling architecture embodiments disclosed herein relates to the position of the cooling volume assembly along the axial length of the battery cells. Before turning to FIGS. 14-18, each of which shows a cooling volume module architecture with a cooling volume assembly at a different cell axial position, reference is made to FIG. 10. In FIG. 10, the cooling volume assembly 560 is located near the bottom ends of the battery cells 510, 512, and 514, and the thermal venting side 540 of the battery cells 510, 512, and 514 is located at the bottom ends too. In particular, an outer surface of the cooling volume assembly is flush with the lower or second ends of the battery cells. The configuration enables the cooling volume assembly 560 to prevent overheating of the battery cell grid by acting as a thermal shield against the hot thermal event gases.

Now referring to FIGS. 14-18, different embodiments showing other possible positions and orientations for the cooling volume assembly are illustrated. Turning to FIG. 14, a current conducting layer 902 is located at one end of the battery cells 910, each of which is surrounded by a sleeve 980. Adjacent to the current conducting layer 902 is a module structural skin 970, and both of them are at the end of the battery cells 910 which is the thermal venting side 940 of the cells 910. The cooling volume assembly 960 is located at the opposite end of the battery cells 910 from the current conducting layer 902 and the module structural skin 970. In this orientation, the cooling volume assembly 960 is located at the upper ends of the battery cells 810, which are vertically oriented. The inlet 962 and the outlet 964 for the cooling volume assembly 960 are orientated downwardly along the direction of the battery cells 910.

Referring to FIG. 15, a current conducting layer 1002 is located at one end (such as the upper end) of the battery cells 1010, which are surrounded by sleeves 1080. A module structure skin 1070 is positioned adjacent to the current conducting layer 1002 as well. In this embodiment, the cooling volume assembly 1060 is oriented so that the inlet 1062 and the outlet 1064 are directed upwardly. In addition, the cooling volume assembly 1060 is located along the battery cells 1010 at an intermediate position 1065, which is located between the opposite ends 1026 and 1028 of the battery cells 1010. In other embodiments, the cooling volume assembly 1060 can be located at other intermediate positions 1065 between the battery cell ends. For example, in FIG. 16, the cooling volume assembly 1160 has been moved along the direction of arrow “A” along the battery cells 1010 to another intermediate position 1166, which is different from the intermediate position 1065 illustrated in FIG. 15, and is between opposite ends 1126 and 1128. Intermediate position 1166 is the axial center position along the length of the battery cells 1110.

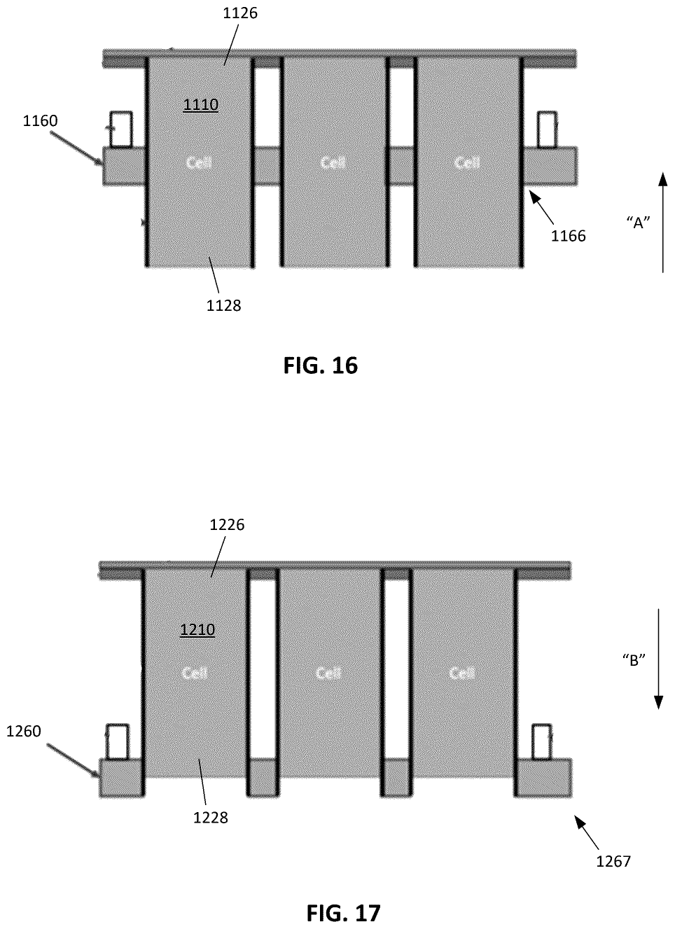

Referring to FIG. 17, battery cells 1210 have opposite ends 1226 and 1228. A cooling volume assembly 1260 has been moved along the direction of arrow “B” to an extended position 1267 relative to the ends 1228 of the battery cells 1210. In this extended position 1267, a first part of the cooling volume assembly 1260 is adjacent to and overlaps with the battery cells 1210 and the other or second part of the cooling volume assembly 1260 extends beyond ends 1228 of the battery cells.

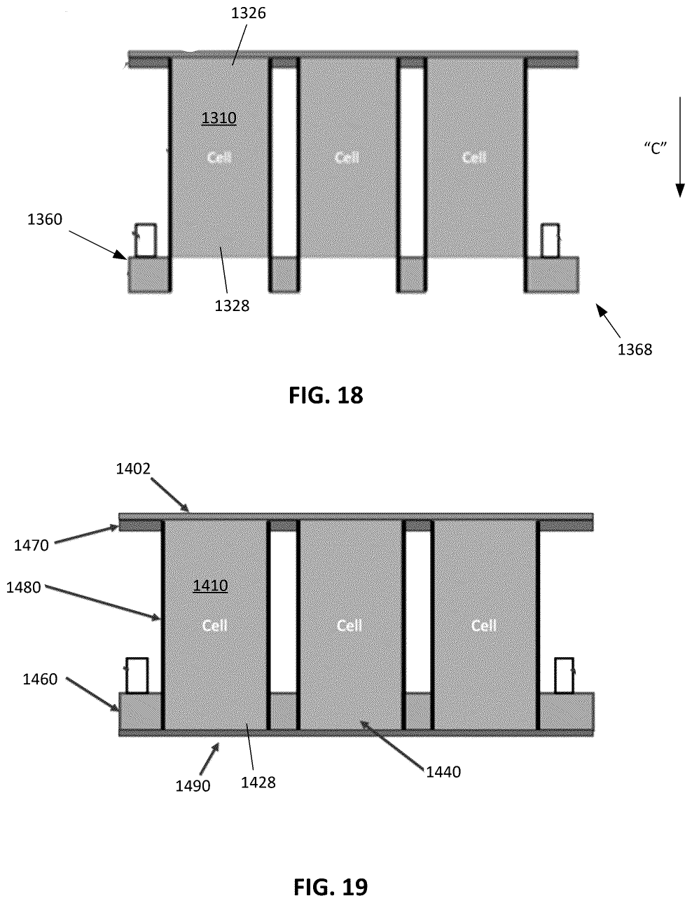

Referring to FIG. 18, battery cells 1310 have opposite ends 1326 and 1328, similar to the previously described battery cells. In this embodiment, a cooling volume assembly 1360 has been moved along the direction of arrow “C” to an extended position 1368 relative to the ends 1328 of the cells 1310. In this extended position 1368, the cooling volume assembly 1360 extends entirely beyond ends 1328 of the battery cells 1310.

Another variation in the battery cooling architecture is the location or position of the current conducting layer or layers. In one implementation, the battery cooling architecture has current conducting layers on the same side as the cooling volume assembly (see FIG. 13). As shown in FIG. 13, the current conducting layers 802 are placed directly on the cooling volume assembly 860. In another implementation, the battery cooling architecture has current conducting layers at the opposite end of the cooling volume assembly (see FIG. 11). Although being placed directly on the cooling volume assembly ensures a better temperature control of the current conducting layers, placing the current conducting layers on the opposite end is also effective in controlling its temperature. Thus, the location of the current conducting layers is determined on the performance, design, manufacturing, or other technical reasons.

In different embodiments, another feature that can be varied is the orientation and quantity of the cooling volume inlets and outlets for the cooling volume assemblies. As described above, the orientation of the inlet fitting and the outlet fitting can be facing downward or upward. In addition, the quantity of inlet fittings and the quantity of outlet fittings can also vary, particularly independent of each other. This orientation and quantities of the fittings are determined based on the cooling tube routing, packaging, and other technical requirements.

In other embodiments, another feature that can be varied is the inclusion or addition of a high temperature thermal shield. Referring to FIG. 19, several battery cells 1410 are surrounded by sleeves 1480 and have at one end a cooling volume assembly 1460 and at the other end a module structural skin 1470 and current conducting layers 1402. The thermal venting side 1440 of the cells 1410 is at the same end as the cooling volume assembly 1460.

In this embodiment, a high temperature material that is a thermal shield 1490 is provided adjacent to the cooling volume assembly 1460 and the ends 1428 of the battery cells 1410. The high temperature thermal shield 1490 shields the exposed cell surfaces facing the thermal vent area as shown in FIG. 19. The material of the thermal shield 1490 allows a battery cell 1410 that goes into thermal runaway to vent with minimal obstruction, but remains intact to protect the rest of the battery cell grid from the high temperature gases coming out.

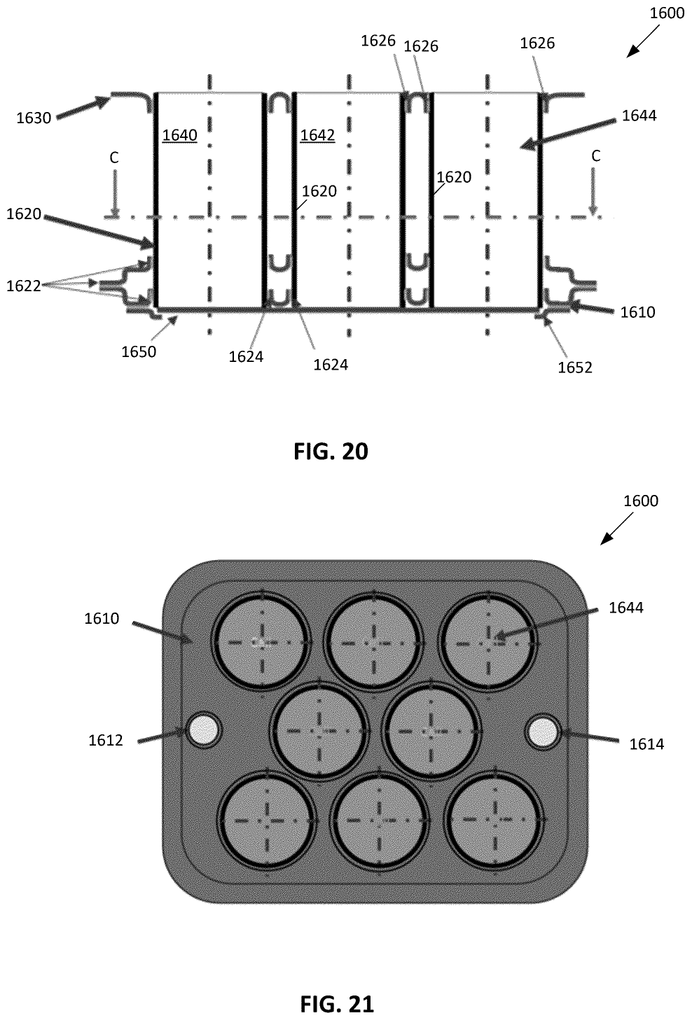

One exemplary way to include a thermal shield in a cooling volume assembly according to the aspects of this disclosure is illustrated in FIGS. 20-21. As shown, the battery cooling architecture 1600 includes a cooling volume assembly 1610 with an inlet 1612 and an outlet 1614, and a module structural skin 1630. Each of the cooling volume assembly 1610 and the module structural skin 1630 is coupled to the sleeves 1620 at multiple locations, including joint areas 1622, 1624, and 1626. In FIG. 20, several battery cells 1640, 1642, and 1644 are illustrated.

In this embodiment, the battery cooling architecture 1600 includes an additional tray 1652, which is a thermal shield support tray 1652. Tray 1652 is located below the cooling volume bottom tray which has several formed portions to weld the tray around the cooling volume perimeter, but also within certain areas within the cell grid in the interstitial spaces left between the metal sleeves. In one embodiment, the high temperature thermal shield 1650 used with cooling volume assembly 1610 can be made of independent circular thermal shield disks. Alternatively, the high temperature thermal shield 1650 can be made of a full piece of material with cutouts just in the areas needed to weld the thermal shield support tray 1652. In one embodiment, the cooling volume bottom tray has a formed perimeter portion to weld to the cooling volume perimeter. In this implementation, the thermal shield is made of a full piece of material.

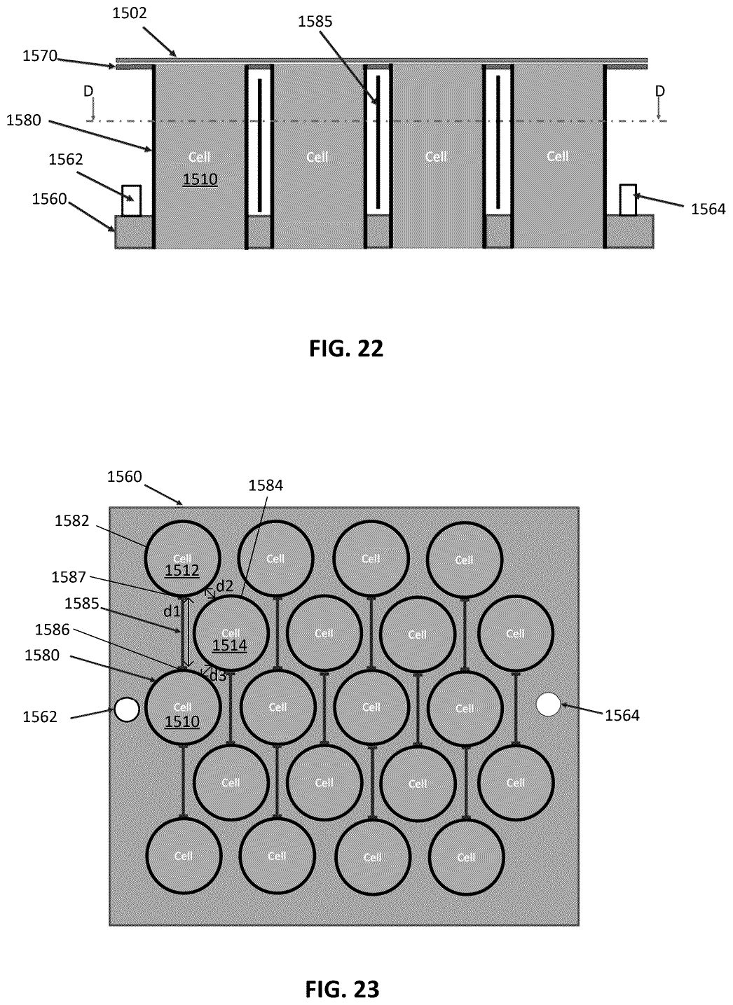

In yet other embodiments, the battery cooling architecture includes heat transfer elements located between battery cells. These heat transfer elements can be referred to as far cell neighbor heat transfer elements. In one implementation, each heat transfer element is a piece of metal that is thermally connected from each cell sleeve to its next row neighbor as illustrated in FIGS. 22-23. FIG. 22 is a side view of this embodiment of a battery cooling architecture, and FIG. 23 is a cross-sectional top view taken along line “D-D” in FIG. 22.

As shown, the battery cooling architecture includes several heat transfer elements 1585, which act as a thermal event safety enhancing measure. The heat transfer elements 1585 allow more direct heat transfer from a hot thermal runaway battery cell to at least one far away neighbor battery cell, instead of an immediately close battery cell, which reduces the amount of heat transferred to an immediate neighboring battery cell. By properly sizing heat transfer elements 1585, the heat produced by a battery cell in a thermal runaway state can be more uniformly shared with the overall battery cell grid. This approach reduces the impact of a thermal runaway battery cell on its neighboring battery cells, since each individual battery cell receives a lower heat input and results in a reaching a lower temperature during a battery cell thermal event. Lower temperature imparting on neighboring battery cells means that those battery cells would have a greater safety margin of going into a thermal runaway. In some instances, the design of the heat transfer elements include thermally fusing to prevent a very high thermal energy transfer.

As shown in FIGS. 22 and 23, many of the features are the same as previous battery cooling architecture embodiments described above, including current conducting layers 1502, a module structural skin 1570, a cooling volume system 1560 with an inlet 1562 and an outlet 1564. Several battery cells 1510 are provided, each of which is surrounded by a sleeve 1580.

In FIG. 22, heat transfer elements 1585 are illustrated in the gaps between adjacent sleeves. Referring to FIG. 23, one of the heat transfer elements 1585 is described in greater detail, noting that this description applies to the other heat transfer elements 1585. Sleeves 1580 and 1582 are positioned around battery cells 1510 and 1512, respectively. Heat transfer element 1585 has opposite ends 1586 and 1587, which are fused to sleeves 1580 and 1582, respectively. Heat can be transferred along element 1585 between cooling sleeve 1580 and cooling sleeve 1582. As shown, heat transfer element 1585 is not connected or coupled to sleeve 1584 for battery cell 1514, which is closer to battery cells 1510 and 1512 than they are to each other. In this embodiment, cooling sleeve 1582 is separated from cooling sleeve 1580 by a first distance “d1”, cooling sleeve 1582 is separated from cooling sleeve 1584 by a second distance “d2”, and cooling sleeve 1580 is separated from cooling sleeve 1584 by a third distance “d3.” The first distance “d1” is larger than the second distance “d2” and larger than the third distance “d3.”

Another variation in different embodiments relates to cooling volume internal structures. In general, a cooling volume assembly does not require an internal structure to perform its main function of cooling the battery cell grid. However, one or more internal elements can be added to the cooling volume assembly to enhance its cooling properties, and its structural and tolerance to internal or external pressure capabilities. For example, an internal fin structure can enhance the cooling capabilities of the cooling volume assembly. Also, internal structural elements could be added to the cooling volume assembly to allow it to sustain higher internal pressures from the hydraulic system, as well as improve its structural integrity against external loads. These structural elements can be a separate piece or pieces that are mechanically joined to the internal walls of the cooling volume assembly. Alternatively, the structural elements can be additional shapes or configurations formed into the cooling volume assembly walls that create additional mechanical joints inside the cooling volume. In some implementations, these structural internal elements can be added for their structural benefit, and also engineered to enhance the cooling volume heat transfer capabilities.

Another variation in different embodiments is whether a cell-to-sleeve adhesive is used. In one implementation, the battery cells are adhered to the cooling volume assembly. Alternatively, the battery cells could also be assembled into the cooling volume assembly without any adhesive. Adhering the battery cells to the cooling volume assembly improves the heat transfer between the battery cells to the cooling volume assembly. In addition, it also improves the full assembly structural integrity. In the alternative, not adhering the battery cells to the cooling volume assembly simplifies the method of manufacturing, and it makes it easier to disassemble the cooling volume assembly for potential repair of the battery pack, or recycling of the cooling volume assembly.

In other embodiments, the shape of the battery cell sleeves can vary. In some embodiments, the shape of the sleeves are cylindrical, with a circular cross-section. In other embodiments, different sleeve cross-sectional shapes can be used, which may improve structural aspects of the cooling volume assembly in different arrangements and configurations.

Also, in various embodiments, the structure of a battery cell grid can vary in terms of layout of the battery cells, the total quantity of battery cells, the rows and/or columns of the battery cells, and the spacing between adjacent battery cells. For example, FIGS. 2B and 4B illustrate views of a battery cell grid that has eight total battery cells arranged in three rows and five columns, noting that the battery cells in adjacent columns overlap each other. Also, FIG. 9 illustrates a view of a battery cell grid that has three total battery cells arranged in a single row. Additionally, FIG. 23 illustrates a view of a battery cell grid that has 20 total battery cells arranged in five rows and eight columns, which overlap adjacent columns. The aspects disclosed herein relate to battery cell grids having a variety of arrangements and quantities of battery cells, and are not limited to the specific battery cell grid arrangements disclosed herein. The aspects relate to battery cell grids that are extended row-wise and/or column-wise as far as desired and possible, including X rows and Y columns of battery cells.

In different embodiments, the cooling fluid used in the cooling volume assembly can vary as well. There is a variety of cooling fluids that can be used in the cooling volume assembly. One fluid is an ethylene glycol/water mixture. Other fluids could include the use of dielectric fluids, which could enable different variants of cooling volume architectures without the need for electrical isolation between the cells and the coolant volume, with all cells sharing the same electrical potential.

In other embodiments, the cooling volume assembly electrical connection can vary. The cooling volume assembly can be used as part of an electrical connection by being connected electrically to the cell cylinder, which allows it to be the common negative side of a group of cells in parallel. The current conducting layers are located to be the cells positive terminal connection. The electrical connection to the rest of the electrical chain can be done on the positive ends to the current collecting layers, and then on the negative ends to the cooling volume assembly. Alternatively, the current collecting layers could take care of both the positive and negative connections by having a negative portion of the current collecting layers being electrically connected to the cooling volume.

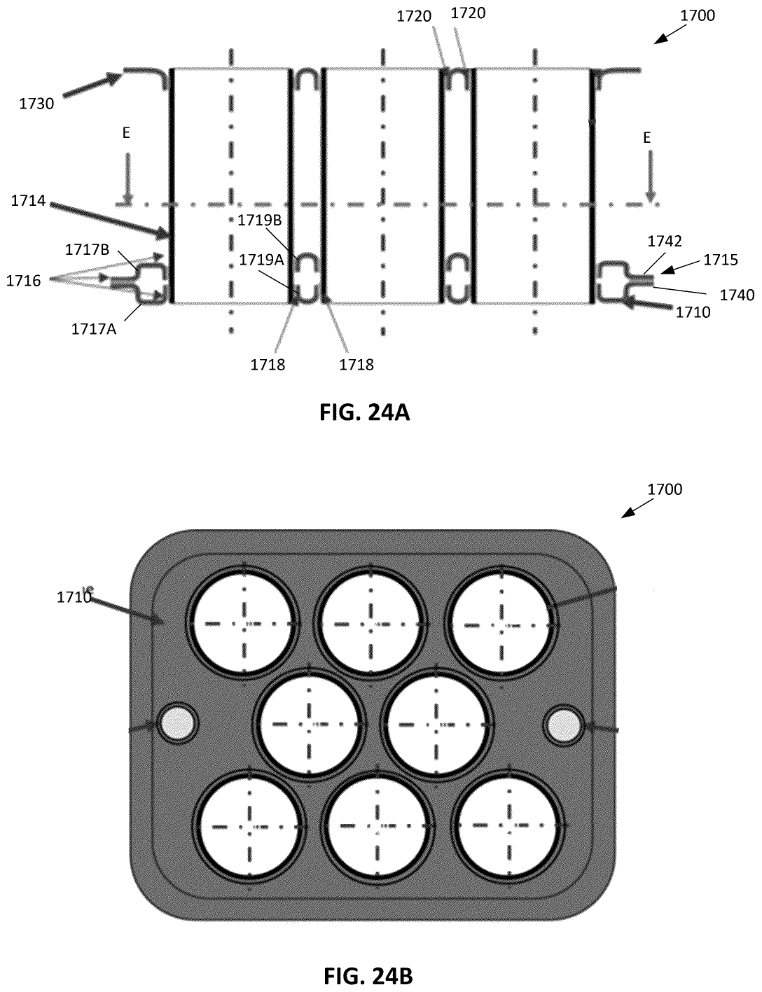

There are several variations of manufacturing the cooling volumes disclosed herein. Referring to FIGS. 24A, 24B, 25A, 25B, 26A, and 26B, different variations of the cooling volume end of the battery cooling architecture are illustrated.

Turning initially to FIGS. 24A and 24B, battery cooling architecture 1700 includes a cooling volume assembly 1710 and a modular structural skin 1730, which are connected to each other via metal sleeves 1714 that extend along the full length of battery cells. The locations at which the cooling volume assembly 1710 and the modular structural skin 1730 are coupled or joined to the sleeves 1714 are shown as joint areas 1716, 1718, and 1720.

Cooling volume assembly 1710 has a bottom tray 1715 that includes a bottom portion 1717A and an upper portion 1717B that are coupled together at joint area 1716. In this embodiment, the inner ends of bottom portion 1717A and upper portion 1717B are oriented toward each other along the sleeves 1714. The bottom tray 1715 includes swage portions 1719A and 1719B. Swage portions 1719B of the bottom tray 1715 are facing upward instead of downward as shown in FIG. 3A. In this embodiment, the bottom portion 1717B has an outwardly extending flange portion 1740 that is coupled to an outwardly extending flange portion 1742 of the upper portion 1717A.

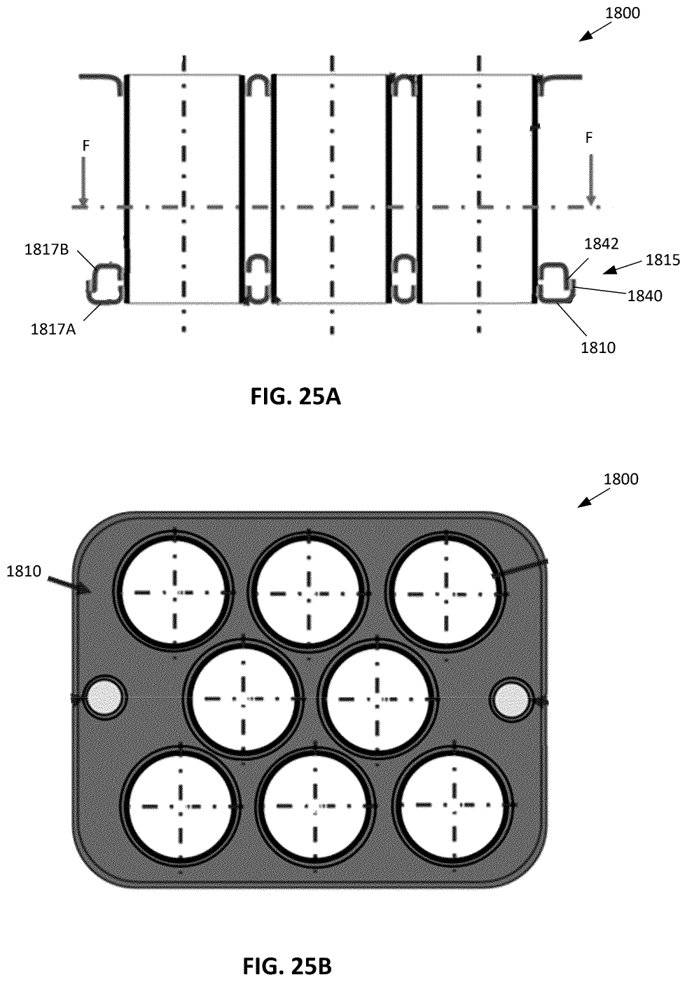

Turning to FIGS. 25A and 25B, battery cooling architecture 1800 includes a cooling volume assembly 1810 that has a bottom tray 1815 with a bottom portion 1817A and an upper portion 1817B that are coupled together. In this embodiment, the bottom portion 1817A has a curved configuration with a flange portion 1840 and the upper portion 1817B has a curved configuration with a flange portion 1842. As shown in FIG. 25A, the flange portions 1840 and 1842 are positioned so that they overlap with each other, which provides a location at which they can be coupled. In this implementation, there are no outwardly extending flanges that can be coupled together. Thus, the cooling volume perimeter weld, which instead of relying on welding the horizontal plane of the trays, relies on a vertical plane of the swaged perimeter of the upper portion or tray 1817B and the bottom portion or tray 1817A of tray 1815. In alternative embodiments, the particular shape and order (such as portion 1840 being inside of portion 1842) can vary in the vertical plane, and any combination of inner and outer surfaces of the swaged perimeters can be used.

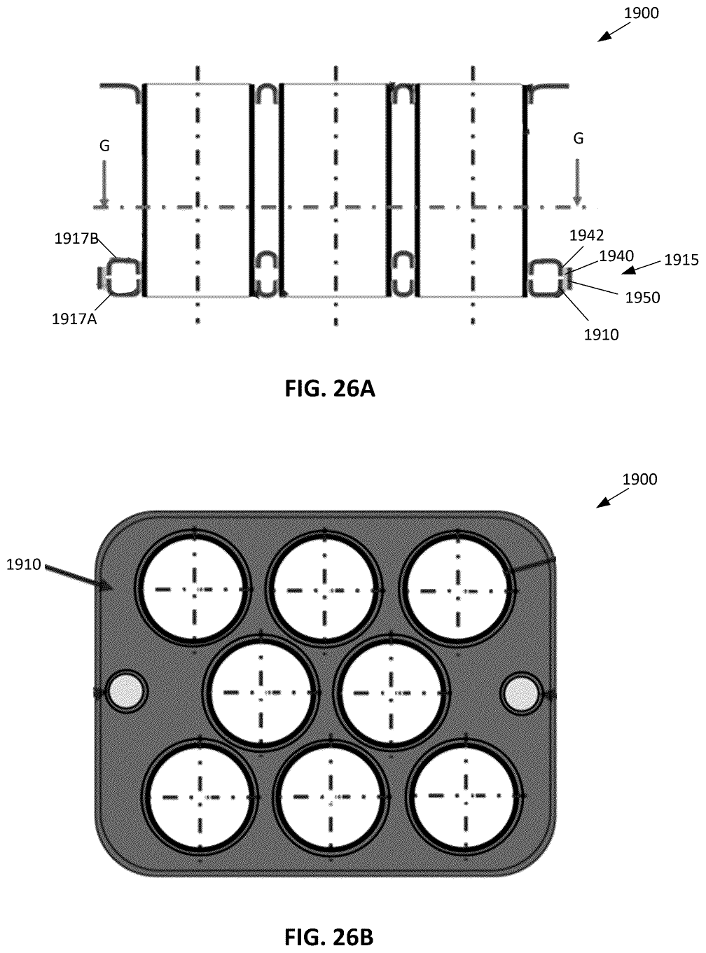

Turning to FIGS. 26A and 26B, battery cooling architecture 1900 includes a cooling volume assembly 1910 that has a bottom tray 1915 with a bottom portion 1917A and an upper portion 1917B that are coupled together. In this embodiment, the bottom portion 1917A has a curved configuration with a coupling portion 1940 and the upper portion 1917B has a curved configuration with a coupling portion 1942. As shown in FIG. 26A, the flange portions 1940 and 1942 are positioned so that their ends are proximate to each other. In this implementation, there are no outwardly extending flanges that can be coupled together. Thus, the cooling volume perimeter weld, which instead of relying on welding the horizontal plane of the trays, relies on a coupler 1950 that wraps around the perimeter of the flange portions 1940 and 1942. The coupler 1950 is welded to the outer area of the swaged perimeter of both the bottom portion 1917A and the upper portion 1917B of tray 1915.

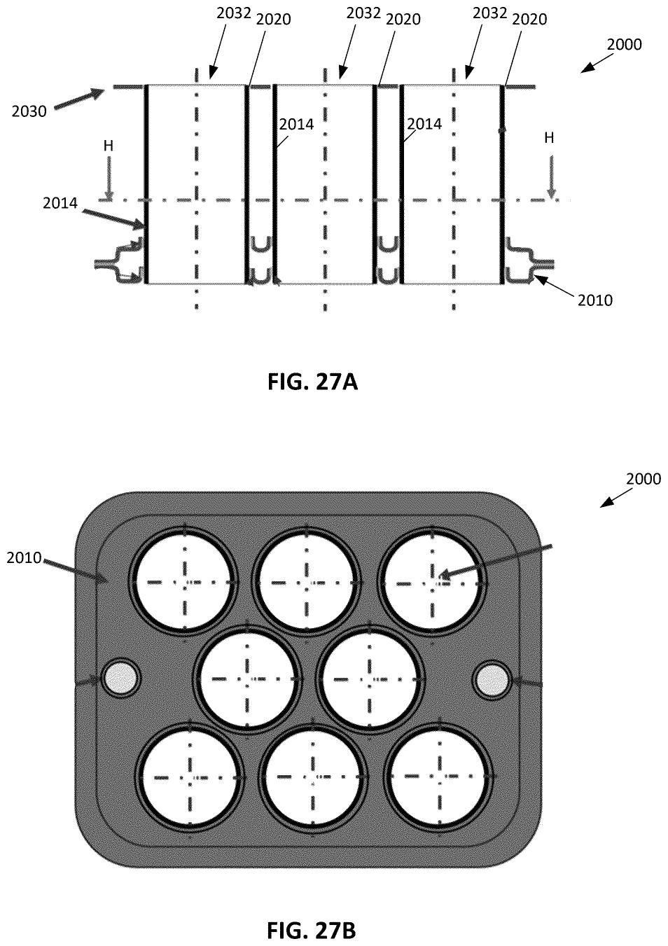

Another variant feature of the battery cooling architecture designs disclosed herein is the shape of the module structural skin. Turning to FIGS. 27A and 27B, battery cooling architecture 2000 includes a cooling volume assembly 2010 and a module structural skin 2030. In this embodiment, instead of being swaged like the module structural skin 190 illustrated in FIG. 3A, the module structural skin 2030 is a flat piece has several circular cutouts 2032 that match the upper ends of sleeves 2014. Each of the cutouts 2032 receives on the sleeves 2014. Instead of relying on the larger surface area of the swages of module structural skin 190, the coupling joints 2020 in this embodiment utilize the area provided by the thickness of the module structural skin 2030 in combination with the circumference of the sleeves 2014. By utilizing less material, manufacturing costs are reduced.

In different uses, the battery cooling architectures disclosed herein can be used with battery packs for electric vehicles, energy storage, electrical vertical take-off and landing aircraft, and other electrical devices and apparatus.

While the invention has been illustrated and described in detail and with reference to specific embodiments thereof, it is nevertheless not intended to be limited to the details shown, since it will be apparent that various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

Similarly, it is intended that the present invention cover the modifications and variations of this invention that come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Finally, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate,” etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially.

What is claimed is:

1. A battery cooling system for use with one or more battery cells, comprising:
a cooling volume assembly defining an interior chamber, the cooling volume assembly including an inlet and an outlet, each of the inlet and the outlet being in fluid communication with the interior chamber; and
a cooling modular structure spaced apart from the cooling volume assembly, wherein the cooling volume assembly and the cooling modular structure cool the one or more battery cells, and a fluid travels through the inlet, the interior chamber, and the outlet of the cooling volume assembly.

2. The battery cooling system of claim 1, wherein a current conducting layer is connected to the one or more battery cells, and the cooling modular structure is placed in contact with the current conducting layer.

3. The battery cooling system of claim 1, wherein each battery cell of the one or more battery cells includes a first end and a second end opposite to the first end, a current conducting layer is connected to the first end of each battery cell, and the cooling modular structure is placed in contact with the second end of each battery cell.

4. The battery cooling system of claim 1, wherein the one or more battery cells defines a perimeter therearound, and the cooling volume assembly extends beyond an entire extent of the perimeter.

5. The battery cooling system of claim 1, wherein each battery cell of the one or more battery cells includes a first end and a second end opposite to the first end, each battery cell including an axial length extending between the first end and the second end.

6. The battery cooling system of claim 5, wherein one of the first end and the second end is a thermal venting side of each battery cell.

7. The battery cooling system of claim 5, wherein the cooling volume assembly is positioned proximate to the second end of each battery cell so that an outer surface of the cooling volume assembly is flush with the second end of each battery cell.

8. The battery cooling system of claim 5, wherein the cooling volume assembly is positioned in an intermediate position along the axial length of each battery cell, and the intermediate position is located between the first end and the second end.

9. The battery cooling system of claim 5, wherein the cooling volume assembly is positioned in an extended position relative to each battery cell, a first part of the cooling volume assembly being adjacent to an outer surface of each battery cell, and a second part of the cooling volume assembly extending beyond the second end of each battery cell.

10. The battery cooling system of claim 5, wherein the cooling volume assembly is positioned in an extended position relative to each battery cell, and the cooling volume assembly extends entirely beyond the second end of each battery cell.

11. The battery cooling system of claim 1, further comprising:
a cooling sleeve located between the cooling volume assembly and the cooling modular structure, the cooling sleeve defining a passageway therethrough, the passageway receiving one of the one or more battery cells therein.

12. The battery cooling system of claim 1, further comprising:
a first cooling sleeve located between the cooling volume assembly and the cooling modular structure, the first cooling sleeve defining a first passageway therethrough, the first passageway receiving a first battery cell therein;
a second cooling sleeve located between the cooling volume assembly and the cooling modular structure, the second cooling sleeve defining a second passageway therethrough, the second passageway receiving a second battery cell therein; and
a heat transfer element coupled to the first cooling sleeve and to the second cooling sleeve.

13. The battery cooling system of claim 12, further comprising:
a third cooling sleeve located between the cooling volume assembly and the cooling modular structure, the third cooling sleeve defining a third passageway therethrough, the third passageway receiving a third battery cell therein, wherein the first cooling sleeve is spaced apart from the second cooling sleeve by a first distance, the first cooling sleeve is spaced apart from the third cooling sleeve by a second distance, and the second cooling sleeve is spaced apart from the third cooling sleeve by a third distance, the first distance being greater than each of the second distance and the third distance.

14. A battery cooling system for use with battery cells having a current conducting layer coupled thereto, the battery cooling system comprising:
a cooling volume assembly defining an interior chamber, the cooling volume assembly including an inlet and an outlet, each of the inlet and the outlet being in fluid communication with the interior chamber, and a cooling fluid travels through the inlet, the interior chamber, and the outlet of the cooling volume assembly;
a cooling modular structure spaced apart from the cooling volume assembly; and
a cooling sleeve connected to and located between the cooling volume assembly and the cooling modular structure, the cooling sleeve defining a passageway in which one of the battery cells is located, wherein the cooling volume assembly, the cooling modular structure, and the cooling sleeve cool the battery cells.

15. The battery cooling system of claim 14, wherein each battery cell of the battery cells includes a first end and a second end opposite to the first end, each battery cell including an axial length extending between the first end and the second end.

16. The battery cooling system of claim 15, wherein the cooling volume assembly is positioned proximate to the second end of each battery cell so that an outer surface of the cooling volume assembly is flush with the second end of each battery cell.

17. The battery cooling system of claim 15, wherein the cooling volume assembly is positioned in an intermediate position along the axial length of each battery cell, and the intermediate position is located between the first end and the second end.

18. The battery cooling system of claim 15, wherein the cooling volume assembly is positioned in an extended position relative to each battery cell, a first part of the cooling volume assembly being adjacent to an outer surface of each battery cell, and a second part of the cooling volume assembly extending beyond the second end of each battery cell.

19. A battery cooling system for use with battery cells in a battery cell grid, the battery cooling system comprising:
a cooling volume assembly defining an interior chamber, the cooling volume assembly including an inlet and an outlet, each of the inlet and the outlet being in fluid communication with the interior chamber;
a first cooling sleeve engageable with the cooling volume assembly, the first cooling sleeve defining a first passageway in which a first battery cell is located;
a second cooling sleeve engageable with the cooling volume assembly, the second cooling sleeve defining a second passageway in which a second battery cell is located; and
a heat transfer element coupled to the first cooling sleeve and to the second cooling sleeve, wherein the heat transfer element can transfer heat energy between the first cooling sleeve and the second cooling sleeve.

20. The battery cooling system of claim 19, further comprising:
a third cooling sleeve engageable with the cooling volume assembly, the third cooling sleeve defining a third passageway in which a third battery cell is located, wherein the first cooling sleeve is spaced apart from the second cooling sleeve by a first distance, the first cooling sleeve is spaced apart from the third cooling sleeve by a second distance, and the second cooling sleeve is spaced apart from the third cooling sleeve by a third distance, the first distance being greater than each of the second distance and the third distance.
